(19) United States
(12) Patent Application Publication
(10) Pub. No.: US 2018/0373357 A1
(43) Pub. Date: Dec. 27, 2018

(54) METHODS, SYSTEMS, AND MEDIA FOR RECOGNITION OF USER INTERACTION BASED ON ACOUSTIC SIGNALS

(71) Applicant: SHENZHEN UNIVERSITY, Shenzhen, Guangdong (CN)

(72) Inventors: Kaishun WU, Shenzhen (CN); Yongpan ZOU, Shenzhen (CN); Weifeng LIU, Shenzhen (CN)

(73) Assignee: SHENZHEN UNIVERSITY, Shenzhen, Guangdong (CN)

(21) Appl. No.: 15/780,270

(22) PCT Filed: Apr. 7, 2016
(86) PCT No.: PCT/CN2016/078665

§ 371 Date: May 31, 2018

(30) Foreign Application Priority Data
Dec. 4, 2015 (CN) 2015108784990

(51) Int. Cl. G06F 3/043; G06F 3/0488

(52) U.S. Cl. CPC G06F 3/043; G06K 9/00335; G06F 3/04883

(57) ABSTRACT

Methods, system, and media for recognition of user interaction based on acoustic signals are disclosed. A method for recognizing user interactions may include: generating an acoustic signal; receiving an echo signal representative of a reflection of the acoustic signal from a target; analyzing, by a computing device, the echo signal; and recognizing a user interaction associated with the target based on the analysis. A system for recognizing user interactions may include: a sound generator to generate an acoustic signal; an echo detector to receive an echo signal representative of a reflection of the acoustic signal from a target; and a processor to analyze the echo signal and recognizing a user interaction associated with the target based on the analysis.

### CROSS-REFERENCE TO RELATED APPLICATIONS

This application claims priority to Chinese Patent Application No. 2015108784990 filed Dec. 4, 2015, the entire contents of which is incorporated herein by reference.

### TECHNICAL FIELD

This application relates to recognition of user interaction. More particularly, this application relates to recognizing user interactions with a computing device and content related to the user interactions based on acoustic signals.

### BACKGROUND

Smart devices, such as mobile phones, tablet computers, and wearable equipment, begin to prevail in our daily life. These smart devices are becoming increasingly portable while possessing superior processing power. However, a reduction of the size of smart devices may make interactions between a user and such smart devices inconvenient. For example, the user may find it difficult to control a mobile device with a small touchscreen using touch gestures and to enter input on the touchscreen.

Accordingly, new mechanisms for facilitating user interactions with the smart devices would be desirable.

### SUMMARY

Methods, systems, and media for recognition of user interaction based on acoustic signals are disclosed. The embodiments of the present disclosure may provide a user-friendly approach to interact with computing devices with excellent resistance to noise. The accuracy of recognition for user interactions such as gesture and writing may be improved and the user's privacy may not be sacrificed.

According to one aspect of the present disclosure, methods for recognizing user interactions are disclosed. The methods include: generating an acoustic signal; receiving an echo signal representative of a reflection of the acoustic signal from a target; analyzing, by a computing device, the echo signal; and recognizing a user interaction associated with the target based on the analysis.

In some embodiments, the acoustic signals includes a near-ultrasonic signal.

In some embodiments, the target includes a user extremity.

In some embodiments, recognizing the user interaction further includes: extracting at least one feature from the echo signal; classifying the at least one feature; and identifying the user interaction based on the classification.

In some embodiments, recognizing the user interaction further includes recognizing, by the computing device, content associated with the user interaction based on the classification.

In some embodiments, recognizing the user interaction further includes recognizing content associated with the user interaction based on at least one processing rule. In some embodiments, the processing rule includes a grammar rule.

In some embodiments, the at least one feature includes at least one of a time-domain feature and/or a frequency-domain feature.

In some embodiments, the time-domain feature includes at least one of an envelope of the echo signal, a peak of the envelope, a crest of the echo signal, a distance between the peak and the crest, and/or any other features of the acoustic signal in a time domain.

In some embodiments, the frequency-domain feature includes a change in frequency of the echo signal.

In some embodiments, the classification is performed based on a classification model.

In some embodiments, the method further includes receiving a plurality of training sets corresponding to a plurality of user interactions; and constructing the classification model based on the plurality of training sets.

In some embodiments, the classification model is a support vector machine, and/or K-nearest neighbor, and/or random forests, and/or any other feasible machine learning algorithms.

In some embodiments, the acoustic signal is generated at a first frequency, wherein the echo signal is detected at a second frequency, and wherein the second frequency is at least twice of the first frequency.

According to another aspect of the present disclosure, systems for recognizing user interactions are disclosed. The systems include a sound generator to generate an acoustic signal; an echo detector to receive an echo signal representative of a reflection of the acoustic signal from a target; and a processor to analyze the echo signal, and recognize a user interaction associated with the target based on the analysis.

According to another aspect of the present disclosure, non-transitory machine-readable storage media for recognizing user interactions are disclosed. The non-transitory machine-readable storage media include instructions that, when accessed by a computing device, causing the computing device to generate an acoustic signal; receive an echo signal representative of a reflection of the acoustic signal from a target; analyze, by the computing device, the echo signal; and recognize a user interaction associated with the target based on the analysis.

### BRIEF DESCRIPTION OF THE DRAWINGS

The present disclosure is further described in terms of exemplary embodiments. These exemplary embodiments are described in detail with reference to the drawings. These embodiments are non-limiting examples, in which like reference numerals represent similar structures throughout the several views of the drawings, and wherein:

FIG. 1 illustrates a system for recognizing user interactions according to some embodiments of the present disclosure;

FIG. 2 illustrates a simplified block diagram of a computing device according to some embodiments of the present disclosure;

FIG. 3 is a flowchart illustrating an example of a process for recognition of user interactions based on acoustic signals according to some embodiments of the present disclosure;

FIG. 4 illustrates a simplified block diagram of a processor according to some embodiments of the present disclosure;

FIG. 5 illustrates a simplified block diagram of an echo analysis module according to some embodiments of the present disclosure;

FIG. 6 shows a flowchart illustrating an example of a process for echo analysis according to some embodiments of the present disclosure;

FIG. 7 illustrates a simplified block diagram of an interaction recognition module according to some embodiments of the present disclosure;

FIG. 8 illustrates a flowchart representing an example of a process for recognition of user interactions according to some embodiments of the present disclosure; and

FIG. 9 illustrates a flowchart representing an example of a process for interaction recognition based on acoustic signals according to some embodiments of the present disclosure.

### DETAILED DESCRIPTION

In accordance with present disclosure, a system for recognition of user interactions based on acoustic signals may be disclosed. The system may include a computing device configured to generate acoustic signals and detect echo signals. The computing device may be any generic electronic device including a sound generator (e.g., a speaker) and an echo detector (e.g., a microphone). For example, the computing device may a smart phone, or a piece of wearable equipment. An echo signal may represent a reflection off any target that comes into the acoustic signals. A user may interact with the computing device through the movements of the target. For example, the user may input content (e.g., text, graphics, etc.) by writing the content on a surface (e.g., desktop, user's arm or clothing, a virtual keyboard, etc.) that is not coupled to the computing device. The computing device may analyze the received echo signal to detect movements of the target and/or to recognize one or more user interaction(s) with the computing device.

In other aspects of the present disclosure, a method for recognition of user interactions based on acoustic signals may be disclosed. The method includes generating an acoustic signal, receiving an echo signal representative of a reflection of the acoustic signal from a target, analyzing, by a computing device, the echo signal; and recognizing a user interaction associated with the target based on the analysis. A non-transitory machine-readable medium for recognizing user interactions based on acoustic signals may be disclosed. The non-transitory machine-readable storage media include instructions that, when accessed by a computing device, causing the computing device to generate an acoustic signal; receive an echo signal representative of a reflection of the acoustic signal from a target; analyze, by the computing device, the echo signal; and recognize a user interaction associated with the target based on the analysis.

The embodiments of the present disclosure may provide a user-friendly approach to interact with computing devices with excellent resistance to noise. The accuracy of recognition for user interactions such as gesture and writing may be improved without enlarging the size of the computing device. Also the user's privacy may not be sacrificed.

In the following detailed description, numerous specific details are set forth by way of examples in order to provide a thorough understanding of the relevant disclosure. However, it should be apparent to those skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

It will be understood that the term “system,” “unit,” “module,” and/or “block” used herein are one method to distinguish different components, elements, parts, section or assembly of different level in ascending order. However, the terms may be displaced by other expression if they may achieve the same purpose.

It will be understood that when a unit, engine, module or block is referred to as being “on,” “connected to” or “coupled to” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The terminology used herein is for the purposes of describing particular examples and embodiments only, and is not intended to be limiting. As used herein, the singular forms “a,” “an,” and “the” may be intended to include the plural forms as well, unless the context clearly indicates otherwise. It will be further understood that the terms “include,” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

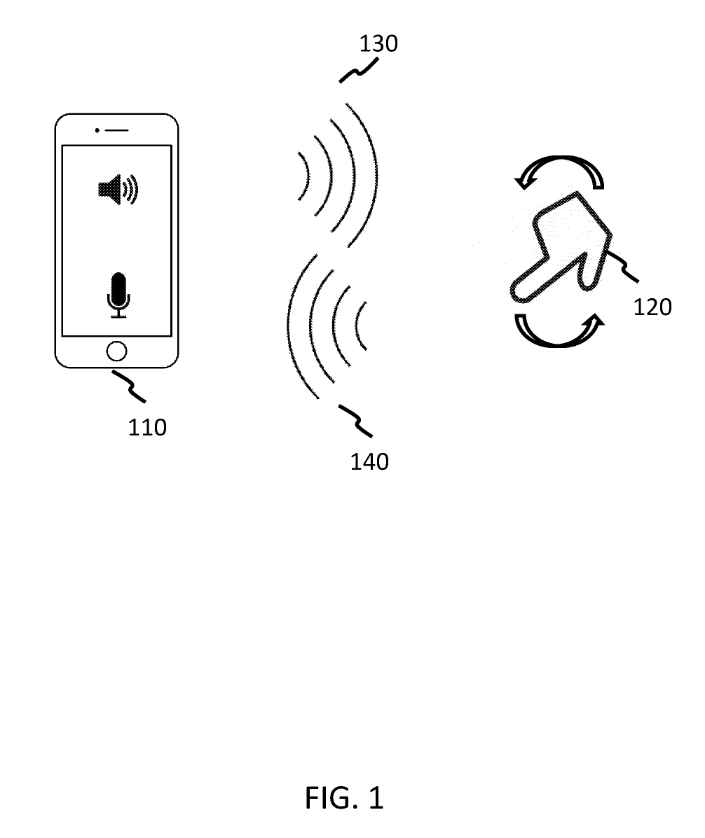

FIG. 1 illustrates a system for recognizing user interactions according to some embodiments of the present disclosure. As shown in FIG. 1, the movement environment includes a computing device 110 and a target 120. In some embodiments, the computing device 110 can be and/or include any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, computing device 110 can be implemented as a mobile phone, a tablet computer, a wearable computer, a digital media receiver, a set-top box, a smart television, a home entertainment system, a game console, a personal computer, a laptop computer, any other suitable computing device, or any suitable combination thereof. In some embodiments, the computing device 110 may be further coupled to an external system (e.g., a cloud server) for processing and storage. Alternatively or additionally, the computing device 110 may be and/or include one or more servers (e.g., a cloud-based server or any other suitable server) implemented to perform various tasks associated with the mechanisms described herein.

In some embodiments, computing device 110 can be implemented in one computing device or can be distributed as any suitable number of computing devices. For example, multiple computing devices 110 can be implemented in various locations to increase reliability and/or processing capability of the computing device 110. Additionally or alternatively, multiple computing devices 110 can be implemented to perform different tasks associated with the mechanisms described herein.

A user can interact with the computing device 110 via movements of the target 120. Merely by way of examples, the target 120 may be a user extremity, such as a finger, multiple fingers, an arm, a face, etc. The target 120 may also be a stylus, a pen, or any other device that may be used by a user to interact with the computing device 110. In some embodiments, the user may interact with the computing device 100 without touching the computing device 110 and/or a device coupled to the computing device 110 (e.g., a keyboard, a mouse, etc.). For example, the user may input content (e.g., text, graphics, etc.) by writing the content on a surface that is not coupled to the computing device 110. As another example, the user may type on a virtual keyboard generated on a surface that is not coupled to the computing device 110 to input content or interact with the computing device 110. As another example, the user may interact with content (e.g., user interfaces, video content, audio content, text, etc.) displayed on the computing device 110 by moving the target 120. In a more particular example, the user may cause one or more operations (e.g., selection, copy, paste, cut, zooming, playback, etc.) to be performed on the content displayed on the computing device 110 using one or more gestures (e.g., “swipe,” “drag,” “drop,” “pinch,” “tap,” etc.). Alternatively or additionally, the user can interact with the computing device 100 by touching one or more portions of the computing device 110 and/or a device coupled to the computing device 110.

The computing device 110 may generate, transmit, process, and/or analyze one or more acoustic signals to recognize user interactions with the computing device 100. For example, the computing device 110 may generate an acoustic signal 130. The acoustic signal 130 may be an infrasound signal, an audio signal, an ultrasound signal, a near-ultrasonic signal, and/or any other acoustic signal. The acoustic signal 130 may be generated by a speaker communicatively coupled to the computing device 110. The speaker may be a stand-alone device or integrated with the computing device 110.

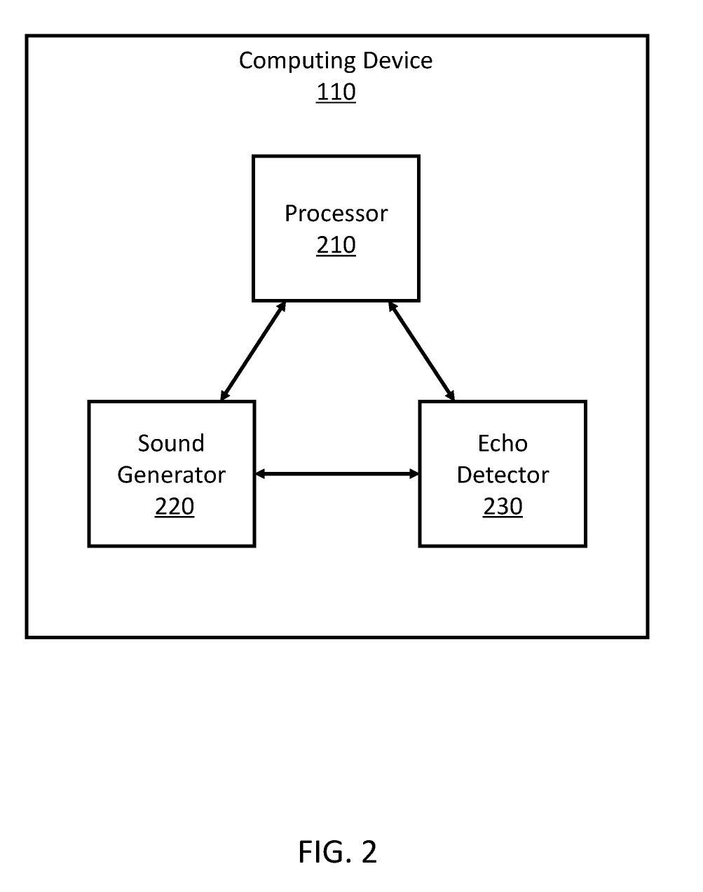

The acoustic signal 130 may travel towards the target 120 and may be reflected from the target 120 once it reaches the target 120. A reflection of the acoustic signal 130 may be referred to as an echo signal 140. The computing device 110 may receive the echo signal 140 (e.g., via a microphone or any other device that can capture acoustic signals). The computing device 100 may also analyze the received echo signal 140 to detect movements of the target 120 and/or to recognize one or more user interaction(s) with the computing device 110. For example, the computing device 110 can recognize content of a user input, such as particular text (e.g., one or more letters, words, phrases, symbols, punctuations, numbers, etc.) entered by a user via movement of the target 120. The particular text may be entered by the user via writing on a surface that is not coupled to the computing device 110 (e.g., by typing on a virtual keyboard generated on such surface). As another example, the computing device 110 can recognize one or more gestures of the target 120. In some embodiments, movements of the target 120 may be detected and the user interaction(s) may be recognized by performing one or more operations described in conjunction with FIGS. 2-9 below.

It should be noted that the movement environment described above is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

FIG. 2 illustrates a simplified block diagram of a computing device according to some embodiments of the present disclosure. As shown, a computing device 110 may include a processor 210, a sound generator 220, and an echo detector 230. The processor 210 may be communicatively coupled to the sound generator 220, the echo detector 230, and/or any other component of the computing device 110. More or less components may be included in computing device 110 without loss of generality. For example, two of the units may be combined into a single units, or one of the units may be divided into two or more units. In one implementation, one or more of the units may reside on different computing devices (e.g., desktops, laptops, mobile phones, tablet computers, wearable computing devices, etc.).

The processor 210 may be any general-purpose processor operable to carry out instructions on the computing device 110. In some embodiments, the processor 210 may be a central processing unit. In some embodiments, the processor 210 may be a microprocessor. Merely by way of examples, a non-exclusive list of microprocessors that may be used in connection with the present disclosure includes an application-specific integrated circuit (ASIC), an application-specific instruction set processor (ASIP), a graphic processing unit (GPU), a physics processing unit (PPU), a digital signal processor (DSP), an image processor, coprocessor, a floating-point unit, a network processor, an audio processor, a field modulatable gate array (FPGA), an acorn reduced instruction set computing (RISC) machine (ARM), or the like, or any combination thereof. In some embodiments, the processor 210 may be a multi-core processor. In some embodiments, the processor 210 may be a front end processor. The processor that can be used in connection with the present system described herein are not exhaustive and are not limiting. Numerous other changes, substitutions, variations, alterations, and modifications may be ascertained to one skilled in the art and it is intended that the present disclosure encompass all such changes, substitutions, variations, alterations, and modifications as falling within the scope of the present disclosure.

The sound generator 220 may be and/or include an electromechanical component configured to generate acoustic signals. One or more of the acoustic signals may represent sound waves with various frequencies, such as infrasound signals, audible sounds, ultrasounds, near-ultrasonic signals, etc. The sound generator 220 is coupled to, and/or communicate with, other components of the computing device 110 including the processor 210 and the echo detector 230. In some embodiments, the sound generator 220 may be and/or include a speaker. Examples of the speaker may include a built-in speaker or any other device that produces sound in response to an electrical audio signal. A non-exclusive list of speakers that may be used in connection with the present disclosure includes loudspeakers, magnetostatic loudspeakers, electrostatic loudspeakers, digital speakers, full-range speakers, mid-range speakers, computer speakers, tweeters, woofers, subwoofers, plasma speakers, etc. The speaker that can be used in connection with the present system described herein are not exhaustive and are not limiting. Numerous other changes, substitutions, variations, alterations, and modifications may be ascertained to one skilled in the art and it is intended that the present disclosure encompass all such changes, substitutions, variations, alterations, and modifications as falling within the scope of the present disclosure. In some embodiments, the sound generator 220 includes an ultrasound generator configured to generate ultrasound. The ultrasound generator may include an ultrasound transducer configured to convert voltage into ultrasound, or sound waves about the normal range of human hearing. The ultrasound transducer may also convert ultrasound to voltage. The ultrasound generator may also include an ultrasound transmission module configured to regulate ultrasound transmission. The ultrasound transmission module may interface with the ultrasound transducers and place the ultrasound transmission module in a transmit mode or a receive mode. In some embodiments, the sound generator 220 can include a digital-to-analog converter

(DAC) to convert a digital signal to a continuous physical quantity. Particularly, the DAC may be configured to convert digital representations of acoustic signals to an analog quantity prior to transmission of the acoustic signals. In some embodiments, the sound generator 220 can include an analog-to-digital converter (ADC) to convert a continuous physical quantity to a digital number that represents the quantity's amplitude. It should be noted that the sound generator described above is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

The echo detector 230 may be configured to detect acoustic signals and/or any other acoustic input. For example, the echo detector 230 can detect one or more echo signals representative of reflections of one or more acoustic signals generated by the sound generator 220. Each of the echo signals may be and/or include an infrasound signal, an audio signal, an ultrasound signal, a near-ultrasonic signal, etc. An echo signal may represent a reflection off any target that comes into the acoustic waves generated by the sound generator 220. In some embodiments, the echo detector 230 can detect acoustic signals with certain frequencies (e.g., a particular frequency, a particular range of frequencies, etc.). For example, the echo detector 230 can detect acoustic signals with a fixed frequency, such as a frequency that is at least twice the frequency of an acoustic signal generated by the sound generator 220. As such, the echo detector may filter out irrelevant echoes and may detect echo signals representative of echo(es) of the acoustic signal. In some embodiments, the echo detector 230 may include an acoustic-to-electric transducer that can convert sound into an electrical signal. In some embodiments, the echo detector may be and/or include a microphone. The microphone may use electromagnetic induction, capacitance change, piezoelectricity, and/or any other mechanism to produce an electrical signal from air pressure variations. In other embodiments, the acoustic-to-electric transducer may be an ultrasonic transceiver. The echo detector 230 may be communicatively coupled to other components of the computing device 110, such as the processor 210 and the sound generator 220.

In various embodiments of the present disclosure, the computing device 110 may further include a computer-readable medium. The computer-readable medium is couple to, and/or communicated with, other components of the computing device 110 including the processor 210, the sound generator 220, and the echo detector 230. The computer-readable medium may be any magnetic, electronic, optical, or other computer-readable storage medium. The computer-readable medium may include a memory configured to store acoustic signals and echo signals. The memory may be any magnetic, electronic, or optical memory.

It should be noted that the computing device described above is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

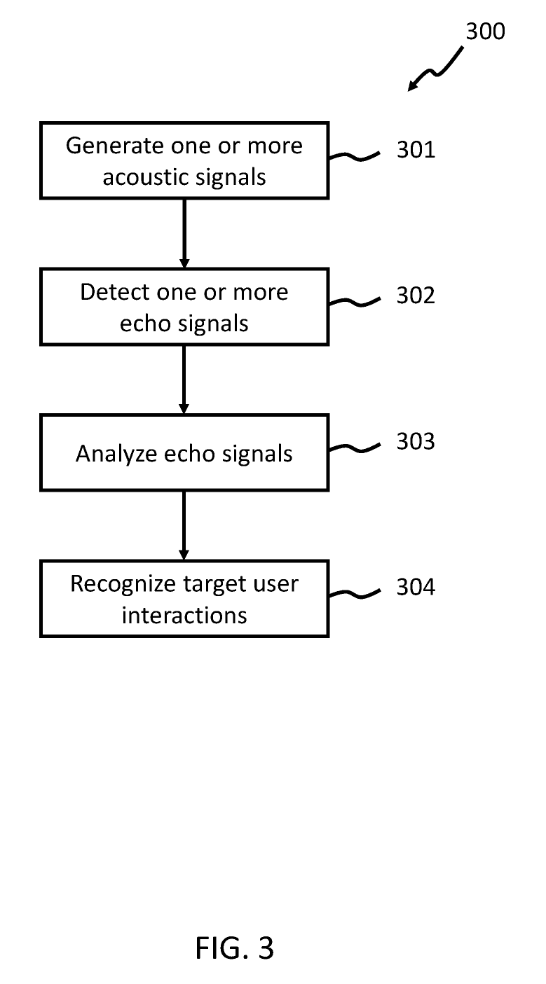

FIG. 3 is a flowchart illustrating an example 300 of a process for recognition of user interactions based on acoustic signals according to some embodiments of the present disclosure. Process 300 may be performed by processing logic that comprises hardware (e.g., circuitry, dedicated logic, programmable logic, microcode, etc.), software (e.g., instructions run on a processing device to perform hardware simulation), or a combination thereof. In some implementations, process 300 may be performed by one or more computing devices (e.g., computing device 101 as described in connection with FIGS. 1-2 above).

As shown, process 300 may begin at step 301 where one or more acoustic signals may be generated. The acoustic signals may be generated by the sound generator 220 of the computing device 110. One or more of the acoustic signals may be infrasound signals, audible sound signals, ultrasound signals, near-ultrasonic signals, etc.

In some embodiments, the acoustic signal(s) may be transmitted. The acoustic signal(s) may be directionally transmitted. For example, the acoustic signals may be transmitted along, or parallel, to a surface. The surface that the acoustic signals transmit along may be a virtual surface. Exemplary surfaces include flat surfaces such as desktops, glasses, and screens. Uneven surfaces may also be used in connection with the present disclosure. For example, the acoustic signals may be transmitted along the surface of a user's arm or clothing. In some embodiments, the user may be allowed to input content on such surfaces via writing or gesturing. In some embodiments, the acoustic signals may project a virtual keyboard on the surface, and the user may be allowed to type on the virtual keyboard to interact with the computing device. In some embodiments, the computing device, or any other external display device, may display a corresponding keyboard to help the user input. Another example, the acoustic signals may be transmitted conically or spherically. The transmitted acoustic signals may come into contract with a target. Acoustic echoes may bounce back and travel towards the computing device 110.

In step 302, one or more echo signals corresponding to the acoustic signal(s) may be detected. The echo signals may be detected by the echo detector 230 of the computing device 110. Each of the echo signals may represent a reflection off a target that comes into the acoustic signals generated by the sound generator 220. In some embodiments, the echo signal(s) may be detected by capturing and/or detecting acoustic signals with particular frequencies (e.g., a particular frequency, a range of frequencies, etc.). For example, the echo detector 230 can detect an echo signal corresponding to an acoustic signal generated at step 301 by detecting acoustic signals with a fixed frequency (e.g., a frequency that is at least twice the frequency of the acoustic signal generated at step 301).

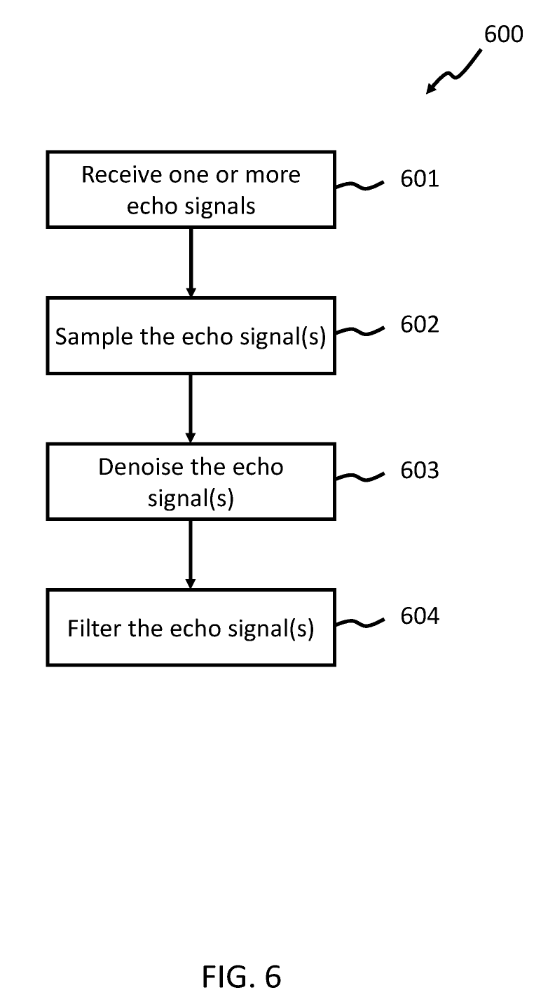

In step 303, the echo signal(s) may be analyzed. For example, the echo signal(s) may be divided into multiple frames. As another example, the echo signal(s) may be filtered, de-noised, etc. As still another example, time-frequency analysis may be performed on the echo signal(s). In some embodiments, the echo signal(s) may be analyzed by performing one or more operations described in conjunction with FIG. 6 below. The analysis of the echo signal(s) may be performed by the processor 210.

In step 304, one or more target user interactions may be recognized based on the analyzed acoustic signal(s). The recognition may be performed by the processor 304 in some embodiments. The target user interaction(s) may be and/or include any interaction by a user with the computing device. For example, the target user interaction(s) may be and/or include one or more gestures, user inputs, etc. Exemplary gestures may include, but not limited to, “tap,” “swipe,” “pinch,” “drag,” “drop,” “scroll,” “rotate,” and “fling.” A user input may include input of any content, such as numbers, text, symbols, punctuations, etc. In some embodiments, one or more gestures of the user, content of a user input, etc. may be recognized as the target user interaction(s).

The target user interaction(s) may be recognized based on a classification model. For example, the computing device may extract one or more features from the analyzed signals (e.g., one or more time-domain features, frequency-domain features, etc.). One or more user interactions may then be recognized by classifying the extracted features based on the classification model. More particularly, for example, the extracted features may be matched with known features corresponding to known user interactions and/or known content. The extracted features may be classified into different categories based on the matching. Each of the categories may correspond to one or more known user interactions, known content (e.g., a letter, word, phrase, sentence, and/or any other content), and/or any other information that can be used to classify user interactions.

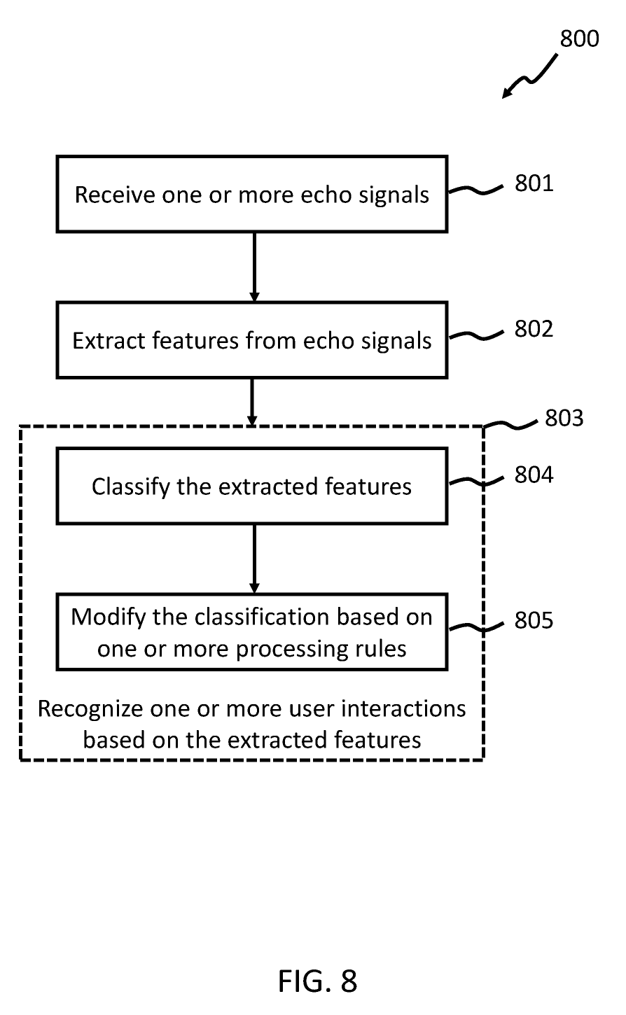

In some embodiments, content related to the target user interaction(s) and/or the target user interaction(s) may be further corrected and/or recognized based on one or more processing rules. Each of the processing rules may be and/or include any suitable rule that can be used to process and/or recognize content. For example, the processing rules may include one or more grammar rules that can be used to correct grammar errors in text. As another example, the processing rules may include one or more natural language processing rules that can be used to perform automatic summarization, translation, correction, character recognition, parsing, speech recognition, and/or any other function to process natural language. More particularly, for example, when a user inputs “task” (e.g., by writing “input” on a surface), the computing device 110 may recognize the input as “tssk” and may further recognize the content of the input as “task” based on one or more grammar rules. In some embodiments, the target user interaction(s) may be recognized by performing one or more operations described in conjunction with FIG. 8 below.

It should be noted that the flowchart described above is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

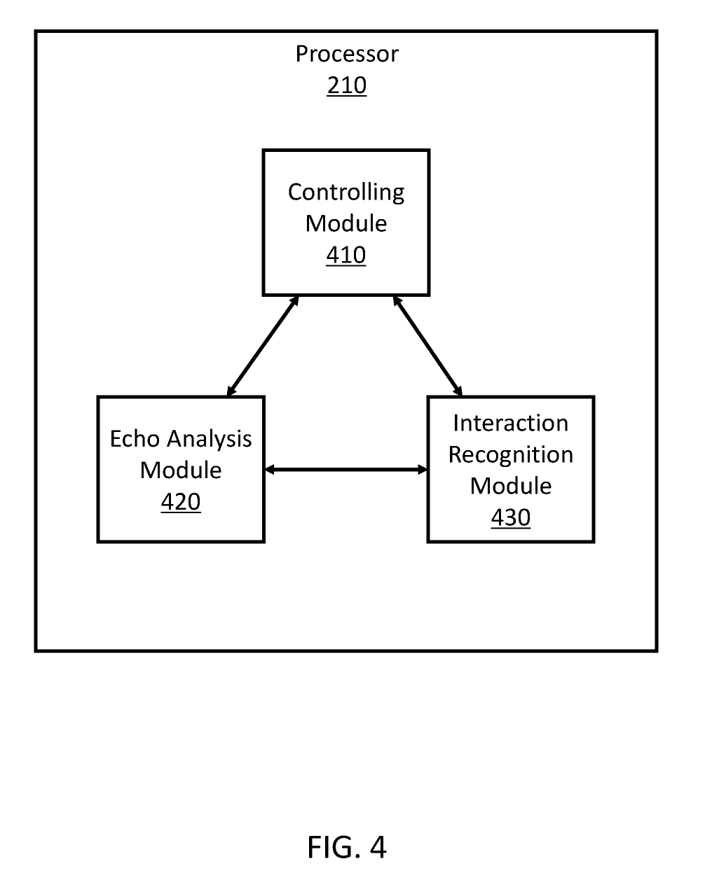

FIG. 4 illustrates a simplified block diagram of a processor according to some embodiments of the present disclosure. As shown, the processor 210 may include a controlling module 410, an echo analysis module 420, and an interaction recognition module 430. More or less components may be included in processor 210 without loss of generality. For example, two of the units may be combined into a single unit, or one of the units may be divided into two or more units. In one implementation, one or more of the units may reside on different processors (e.g., ASIC, ASIP, PPU, audio processor, etc.).

The controlling module 410 may be configured to control other components of the computing device 110 and to execute commands. In some embodiments, the computing device 110 may be coupled to an external system, and the controlling module 410 may be configured to communicate with the external system and/or to follow/generate instructions from/to the external system. In some embodiments, the controlling module 410 may be communicatively coupled to the sound generator 220 and the echo detector 230. The controlling module 410 may be configured to activate the sound generator 220 to generate acoustic signals. The controlling module 410 may determine certain features of the acoustic signals to be generated. For example, the controlling module 410 may determine one or more time-domain features, frequency- domain features, and amplitude feature of the acoustic signals to be generated, and send these information to the sound generator 220 to generate the acoustic signals accordingly. The controlling module 410 may determine the duration of activation of the sound generator 220. The controlling module 410 may also be configured to instruct the sound generator 220 to stop generation of the acoustic signals.

The controlling module 410 may be configured to activate the echo detector 230 to detect echo signals. The controlling module 410 may determine a duration of activation of the echo detector 230. The controlling module 410 may also be configured to instruct the echo detector 230 to stop detection of echo signals. The controlling module 410 may instruct the acoustic-to-electric transducer of the echo detector 230 to transform acoustic signals into electrical signals. The controlling module 410 may instruct the echo detector 230 to transmit the electrical signals to echo analysis module 420 and/or interaction recognition module 430 of the processor 210 for further analysis.

The controlling module 410 may be communicatively coupled to the echo analysis module 420 and the interaction recognition module 430. The controlling module 410 may be configured to activate the echo analysis module 420 to perform echo analysis. The controlling module 410 may send certain features that it uses to instruct the sound generator 220 to the echo analysis module 420 for echo analysis.

The controlling module 410 may be configured to activate the interaction recognition module 430 to perform movement recognition. The controlling module 410 may send certain features that it uses to instruct the sound generator 220 to the interaction recognition module 430 for movement recognition.

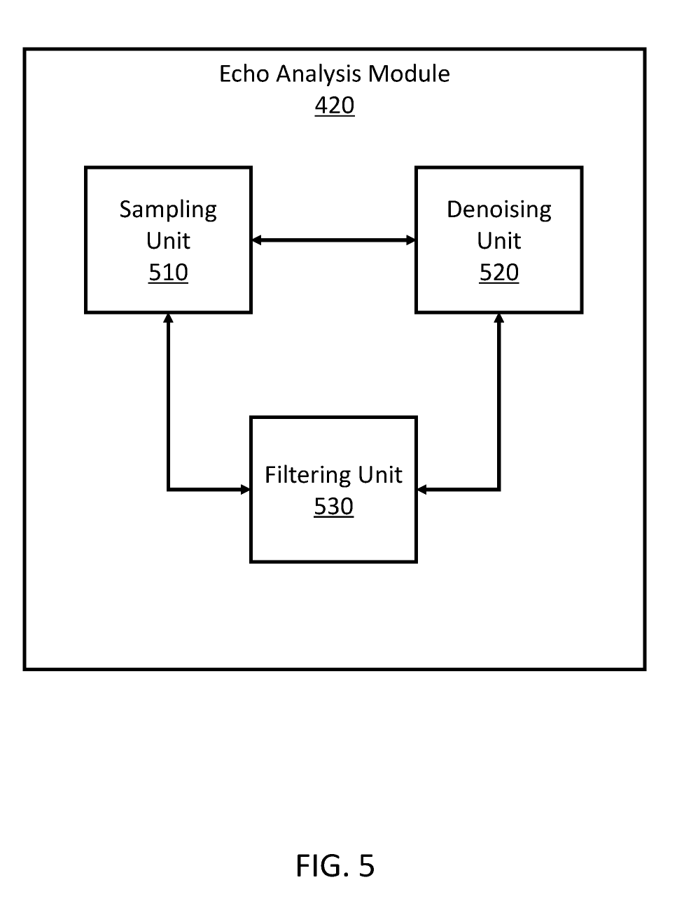

The echo analysis module 420 may be configured to process and/or analyze one or more acoustic signals, such as one or more echo signals. The processing and/or analysis may include framing, denoising, filtering, etc. The echo analysis module 420 may analyze the electrical signals transformed from acoustic echoes by the echo detector 230. The acoustic echoes may be reflected off the target 120. Details regarding the echo analysis module 420 will be further illustrated in FIG. 5.

The interaction recognition module 430 may be configured to recognize one or more user interactions and/or content related to the user interaction(s). For example, content of a user input, such as particular text (e.g., one or more letters, words, phrases, symbols, punctuations, numbers, characters, etc.) entered by a user via movement of the user. As another example, one or more gestures of the user may be recognized.

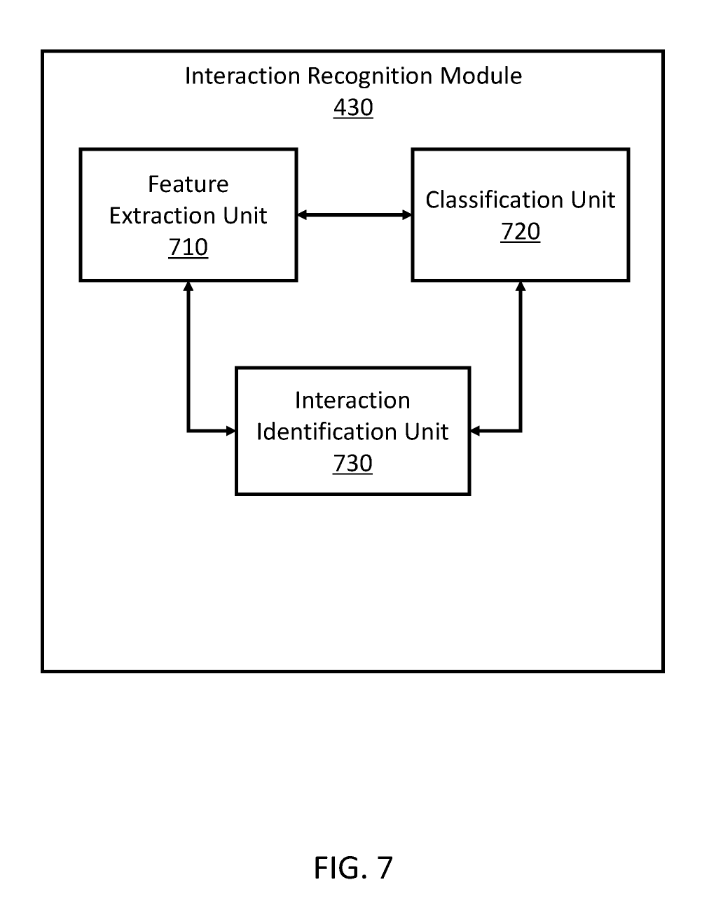

Examples of the gestures may include “tap,” “swipe,” “pinch,” “drag,” “scroll,” “rotate,” “fling,” etc. The user interaction(s) and/or the content may be recognized based on the analyzed signals obtained by echo analysis module 420. For example, the interaction recognition module 430 can process the analyzed signals using one or more machine learning and/or pattern recognition techniques. In some embodiments, the user interaction(s) and/or the content may be recognized by performing one or more operations described in connection with FIG. 7 below.

It should be noted that the processor 210 described above is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

FIG. 5 illustrates a simplified block diagram of an echo analysis module according to some embodiments of the present disclosure. As shown, an echo analysis module 420 may include a sampling unit 510, a denoising unit 520, and a filtering unit 530. The echo analysis module 420 may analyze the electrical signals transformed from acoustic echoes by the echo detector 230. The acoustic echoes may be reflected off the target 120. More or less components may be included in echo analysis module 420 without loss of generality. For example, two of the units may be combined into a single unit, or one of the units may be divided into two or more units. In one implementation, one or more of the units may reside on different modules.

The sampling unit 510 may be configured to frame the electrical signals. By framing the electrical signals, the sampling unit 510 divides the electrical signals into multiple segments. Each segment may be referred to as a frame. Multiple frames may or may not be overlapping with each other. The length of each frame may be about 10˜30 ms. In some embodiments where the frames are overlapping, the overlapped length may be less than half of the length of each frame.

The denoising unit 520 is configured to perform noise reduction. The denoising unit 520 may remove, or reduce noises from the electrical signals. The denoising unit 520 may perform noise reduction to the frames generated by the sampling unit 510. The denoising unit 520 may also perform noise reduction to electrical signals generated by the echo detector 230. The noise that may be removed may be random or white noise with no coherence, or coherent noise introduced by the computing device 110's mechanism or processing algorithms embedded within the unit. For example, the noise that may be removed may be hiss caused by random electrons stray from their designated path. These stray electrons influence the voltage of the electrical signals and thus create detectable noise.

The filtering unit 530 is configured to perform filtration. The filtering unit 530 may include a filter that removes from the electrical signals some unwanted component or feature. Exemplary filters that may be used in connection with the present disclosure include linear or non-linear filters, time-invariant or time-variant filters, analog or electrical filters, discrete-time or continuous-time filters, passive or active filters, infinite impulse response or finite impulse response filters. In some embodiments, the filter may be an electrical filter. In some embodiments, the filter may be a Butterworth filter. In some embodiments, the filtering unit 530 may filter the electrical signals generated by the echo detector 230. In some embodiments, the filtering unit 530 may filter the frames generated by the sampling unit 510. In some embodiments, the filtering unit 530 may filter the denoised signals generated by the denoising unit 520.

It should be noted that the echo analysis module 420 described above is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

FIG. 6 shows a flowchart illustrating an example 600 of a process for echo analysis according to some embodiments of the present disclosure. Process 600 may be performed by processing logic that comprises hardware (e.g., circuitry, dedicated logic, programmable logic, microcode, etc.), software (e.g., instructions run on a processing device to perform hardware simulation), or a combination thereof. In some implementations, process 600 may be performed by one or more computing devices executing the analysis module 420 of FIGS. 4 and 5.

As shown, process 600 may begin by receiving one or more echo signals in step 601. Each of the echo signals may represent a reflection of an acoustic signal from a target. For example, each of the echo signals may be an echo signal 140 as described in connection with FIGS. 1-2 above.

In step 602, the echo signal(s) may be sampled. For example, one or more of the received echo signals may be divided into multiple frames. Adjacent frames may or may not overlap with each other. The sampling may be performed by the sampling unit 510 of the echo analysis module 420.

In step 603, the echo signal(s) may be denoised. For example, the echo signal(s) received at 601 and/or the frames obtained at 602 may be processed using any suitable noise reduction technique. The noise that may be removed may be random or white noise with no coherence, or coherent noise introduced by the computing device 110's mechanism or processing algorithms embedded within the unit. The step 602 may be performed by the denoising unit 520 of the echo analysis module 420.

In step 604, the echo signal(s) may be filtered. The step 604 may be performed by the filtering unit 530 of the echo analysis module 420. The echo signals to be filtered may be the denoised frames obtained from step 602. Through filtration, noises and clutters may be removed from the echo signal(s).

It should be noted that the flowchart described above is provided for the purposes of illustration, and not intended to limit the scope of the present disclosure. Apparently for persons having ordinary skills in the art, numerous variations and modifications may be conducted under the teaching of the present disclosure. However, those variations and modifications may not depart the protecting scope of the present disclosure.

FIG. 7 illustrates a simplified block diagram of an interaction recognition module according to some embodiments of the present disclosure. As shown in FIG. 7, the interaction recognition module 430 may include a feature extraction unit 710, a classification unit 720, and an interaction identification unit 730. More or less components may be included in interaction recognition module 430 without loss of generality. For example, two of the units may be combined into a single units, or one of the units may be divided into two or more units. In one implementation, one or more of the units may reside on different modules.

The feature extraction unit 710 may be configured to extract features from various acoustic signals, such as one or more signals generated by the sound generator 220, the echo analysis module 420, and/or any other device. For example, one or more features may be extracted from one or more frames of an acoustic signal, an analyzed signal generated by the echo analysis module 420 (e.g., one or more frames, denoised frames and/or signals, filtered frames and/or signals, etc.)

An acoustic signal to be processed by the feature extraction unit 710 may correspond to known user interactions, known content, user interactions to be classified and/or recognized (e.g., target user interactions), and/or any other information related to user interactions. For example, the acoustic signal may be a training signal representing training data that may be used to train an interaction identifier. In a more particular example, the training signal may include an echo signal corresponding to one or more particular user interactions (e.g., a particular gesture, a user input, etc.). In another more particular example, the training signal may include an echo signal corresponding to particular content related to a user interaction (e.g., entering particular text). As another example, the acoustic signal may be a test signal representing test data to be classified and/or recognized. More particularly, for example, the text signal may include an echo signal corresponding to a target user interaction to be recognized.

Features that may be extracted from an acoustic signal may include one or more time-domain features, one or more frequency-domain features, and/or any other feature of the acoustic signal. The time domain features of the acoustic signal may include one or more envelopes of the acoustic signal (e.g., an upper envelope, a lower envelope, etc.), a peak of the envelope(s), a crest of the acoustic signal, a distance between the peak and the crest, and/or any other feature of the acoustic signal in a time domain. As used herein, “envelope” may refer to a curve outlining the extremes of a signal. The frequency-domain features may be and/or include one or more frequency components of the acoustic signal, a change in frequency of the acoustic signal over time, etc. The target that comes into the acoustic signal may be located. A distance from the target to the computing device may be calculated by measuring the time between the transmission of the acoustic signal and the received echo signal. The movement of target may induce Doppler Effect. The frequency of the acoustic echoes received by the echo detector 230 may be changed while the target 120 is moving relative to the computing device 110. When the target 120 is moving toward the computing device 110, each successive echo wave crest is emitted from a position closer to the computing device 110 than the previous wave. Hence, the time between the arrivals of successive wave crests at the echo detector 230 is reduced, causing an increase in the frequency. If the target 120 is moving away from the computing device 110, each echo wave is emitted from a position farther from the computing device 110 than the previous wave, so the arrival time between successive waves is increased, reducing the frequency.

The classification unit 720 may be configured to construct one or more models for interaction identification (e.g., classification models). For example, the classification unit 720 can receive training data from the feature extraction unit 701 and can construct one or more classification models based on the training data. The training data may include one or more features extracted from echo signals corresponding to known user interactions and/or known content. The training data may be processed using any suitable pattern recognition and/or machine learning technique. The training data may be associated with their corresponding user interactions (e.g., an input of a given letter, word, etc.) and may be classified into various classifications based on such association. In some embodiments, a classification model may be trained using any suitable machine learning technique and/or combination of techniques, such as one or more of decision tree learning, association rule learning, artificial neural networks, inductive logic modulating, support vector machines, clustering, Bayesian networks, reinforcement learning, representation learning, similarity and metric learning, sparse dictionary learning, genetic algorithms, and/or any other machine learning technique.

The interaction identification unit 730 may be configured to identify one or more target user interactions and/or content related to the user interaction(s). For example, the interaction identification unit 730 can receive, from the feature extraction unit 710, one or more features of test signals corresponding to one or more target user interactions. The interaction identification unit 730 can then classify the features into one or more classes corresponding to particular user interactions and/or content. The classification may be performed based on one or more classification models constructed by the classification unit 720. For example, the interaction identification unit 730 can match the features of the test signals with known features of training signals associated with a particular user interaction, particular content, (e.g., particular text), etc. In some embodiments, the classification may be performed using any suitable machine learning and/or pattern recognition technique.

In some embodiments, the result of the classification may be corrected and/or modified based on one or more processing rules, such as one or more grammar rules, natural language processing rules, linguistic processing rules, and/or any other rule that can be implemented by a computing device to process and/or recognize content.

In some embodiments, the interaction identification unit 730 may provide information about the identified user interaction(s) and/or content to a display device for presentation. In some embodiments, the interaction recognition module 430 may further include an update unit (not shown in the figure). The update unit may be configured to obtain training set (e.g., test signals) to train the classification model. The update unit may be configured to update the classification model regularly. For example, the update unit may update the training set daily, every other day, every two days, weekly, monthly, annually, and/or every any other time intervals. As another example, the update unit may update the training set following particular rules, such as, while obtaining 1,000 training items, the update unit may train the classification model one. The interaction recognition module that can be used in connection with the present system described herein are not exhaustive and are not limiting. Numerous other changes, substitutions, variations, alterations, and modifications may be ascertained to one skilled in the art and it is intended that the present disclosure encompass all such changes, substitutions, variations, alterations, and modifications as falling within the scope of the present disclosure.

FIG. 8 illustrates a flowchart representing an example 800 of a process for recognition of user interactions according to some embodiments of the present disclosure. Process 800 may be performed by processing logic that comprises hardware (e.g., circuitry, dedicated logic, programmable logic, microcode, etc.), software (e.g., instructions run on a processing device to perform hardware simulation), or a combination thereof. In some implementations, process 800 may be performed by one or more computing devices executing the interaction recognition module 430 of FIGS. 4 and 7.

As shown, process 800 may begin by receiving one or more echo signals in step 801. The echo signal(s) may include one or more analyzed echo signals produced by the echo analysis module 420. Each of the echo signal(s) may correspond to one or more user interactions to be recognized. Each of the echo signal(s) may include information about movements of a target that causes such user interaction(s).

In step 802, the computing device may extract one or more features from the echo signal(s). Step 802 may be performed by the feature extraction unit 710. The features that may be extracted may include one or more time-domain features, frequency-domain features, etc. The time domain features may include envelopes, the crest of the envelopes, and the crest of the waves. The envelopes may be smoothed.

The distance between the crests of an envelope and the crests of the waves may be calculated. The frequency-domain features may include a change in frequency of the acoustic signal(s).

In step 803, one or more user interactions may be recognized based on the extracted features. For example, a user interaction can be identified as a particular gesture, a type of input (e.g., an input of text, etc.), etc. As another example, content of a user interaction may be identified (e.g., text entered via the user interaction). This step may be performed by the interaction identification unit 730. In some embodiments, the user interaction(s) and/or the content may be identified by performing one or more of steps 804 and 805.

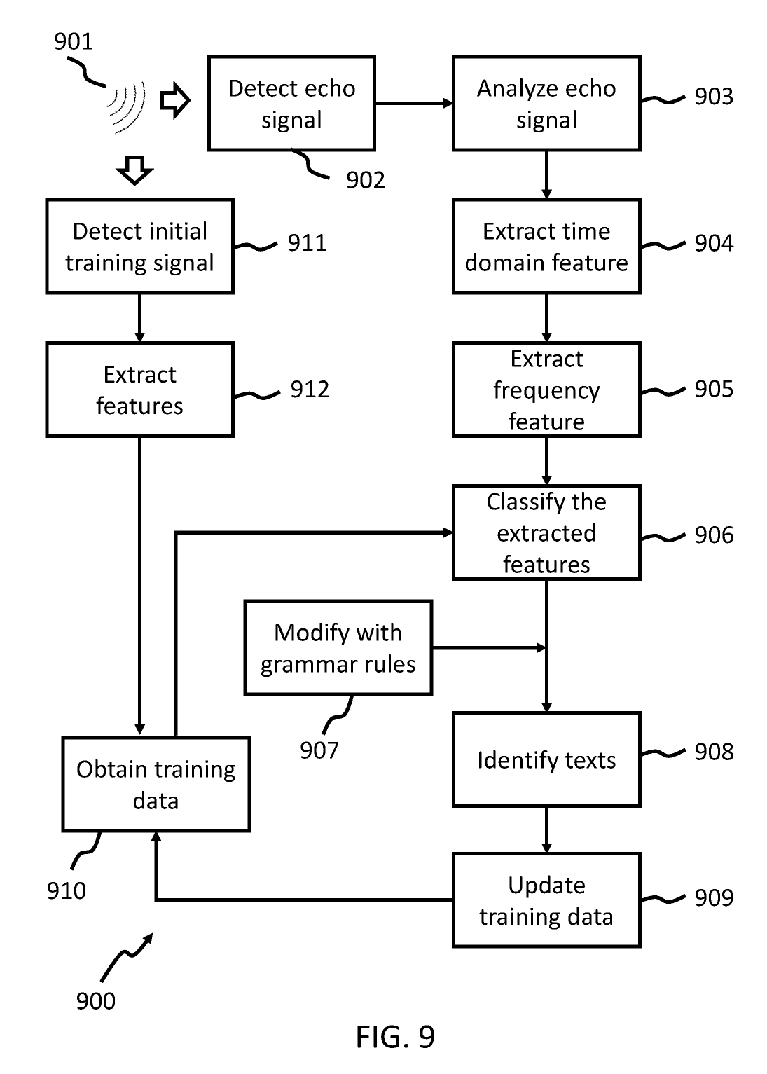

In step 804, the extracted features may be classified. For example, each of the extracted features may be assigned to one or more classes corresponding to user interactions and/or content. Multiple classes may correspond to different user interactions and/or content. For example, a first class may correspond to a first user interaction (e.g., one or more particular gestures) while a second class may correspond to a second user interaction (e.g., input of content). As another example, a third class may correspond to first content (e.g., an input of “a”) while a fourth class may correspond to second content (e.g., an input of “ab”). In a more particular example, one or more of the extracted features may be classified as an input of particular text (e.g., “tssk,” “t,” “s,” “k,” etc.). In another more particular example, one or more of the extracted features may be classified as a particular gesture. The classification may be performed based on a classification model, such as a model trained by the classification unit 720. Details regarding the training of the classification model will be illustrated in FIG. 9. The extracted features may be matched with known features of echo signals that correspond to known user interactions and/or content. In some embodiments, the classification model may be a support vector machine (SVM).

In step 805, the results of classification may be corrected and/or modified based on one or more processing rules. The processing rules may include one or more grammar rules, natural language processing rules, and/or any other suitable rule that can be implanted by a computing device to perform content recognition. For example, when a user writes “task” and the computing device 110 recognizes the writing as “tssk”, the misspelled result may be corrected to “task” by combining with grammar rules.

It should be noted that the flowchart described above is provided for the purposes of illustration, and not intended to limit the scope of the present disclosure. Apparently for persons having ordinary skills in the art, numerous variations and modifications may be conducted under the teaching of the present disclosure.

However, those variations and modifications may not depart the protecting scope of the present disclosure.

FIG. 9 illustrates a flowchart representing an example 900 of a process for interaction recognition based on acoustic signals according to some embodiments of the present disclosure. Process 900 may be performed by processing logic that comprises hardware (e.g., circuitry, dedicated logic, programmable logic, microcode, etc.), software (e.g., instructions run on a processing device to perform hardware simulation), or a combination thereof. In some implementations, process 800 may be performed by one or more computing devices executing the echo analysis module 420 of FIGS. 4 and 5 and interaction recognition module 430 of FIGS. 4 and 7.

As illustrated, process 900 may begin by receiving one or more echo signals 901 in step 902. The echo signal(s) may be representative of reflections of one or more acoustic signals generated by the sound generator 220. Each of the echo signals(s) may include information about a target user interaction. This step may be performed by the echo detector 230 of the computing device 110. In some embodiments, the acoustic echo may be detected by the echo detector 230 at a fixed frequency. In some embodiments, the fixed frequency that the echo detector detecting is at least twice of the frequency of the acoustic waves generated by the sound generator 220. The detected acoustic echo may be transformed into one or more electrical signals (e.g., echo signals). The transform of acoustic echo into electrical signals may be performed by the acoustic-to-electric transducer of the echo detector 230.

In step 903, one or more echo signals may be analyzed. This step may be performed by the echo analysis module 420. In some embodiments, the echo signals to analyze is the electrical signals transformed from the detected acoustic echo. The analysis may include sampling, denoising, filtering, etc.

In step 904, one or more time-domain features of the acoustic signal(s) may be extracted. This step may be performed by the feature extraction unit 710 of the interaction recognition module 430. The time domain features of the acoustic signal may include one or more envelopes, a peak of the envelope(s), a crest of the acoustic signal, a distance between the peak and the crest, and/or any other feature of the acoustic signal in a time domain.

In step 905, one or more frequency-domain features of the echo signal(s) may be extracted. This step may be performed by the feature extraction unit 710 of the interaction recognition module 430. The frequency domain feature may be and/or include one or more frequency components of the acoustic signal, a change in frequency of the acoustic signal over time, etc. To extract the frequency domain feature, the electrical signals may be analyzed using Fourier-related transform. In some embodiments, the Fourier-related transform may be short-time Fourier transform.

In step 906, the extracted features may be classified. This step may be performed by the classification unit 720 of the interaction recognition module 430. The classification may be performed based on a classification model, and in this particular embodiment, a model trained by the classification unit 720 with training set obtained in step 910. In a particular embodiment, the classification model is a support vector machine. The extracted features may be matched with known features of echo signals that correspond to known user interactions and/or content. One or more of the extracted features may be classified as an input of particular text (e.g., “tssk”, “t,” “s,” “k,” etc.).

In step 907, the results of classification may be modified based on grammar rules. This step may be performed by the interaction identification unit 730. For example, when a user writes “task” and the computing device 110 recognizes the writing as “tssk”, the misspelled result may be corrected to “task” by combining with grammar rules.

In step 908, the text that the user input may be identified. This step may be performed by the interaction identification unit 730.

In step 909, training data may be updated. For example, the training data may be updated based on the extracted time-domain feature(s), extracted frequency-domain feature(s), the classification results, the identified content, the identified user interaction, etc. More particularly, for example, one or more of the extracted time-domain feature(s) and/or the extracted frequency-domain features can be associated with the identified content and/or user interaction and can be stored as training data. One or more of the extracted features may be added into the training data in step 910. The updated training data can be used for subsequent classification and/or identification of user interactions. In some embodiments, the training data may be updated by the interaction recognition module 430.

Steps 911 and 912 illustrate another pathway for obtaining training set to train the classification model. In step 911, one or more initial training signals may be detected. Each of the initial training signals may correspond to particular user interaction(s) and/or content associated with the user interaction(s). For example, each of the initial training signals may be and/or include an echo signal representative of a reflection of an acoustic signal detected when one or more users engage in particular user interaction(s). As another example, each of the initial training signals may be and/or include an echo signal representative of a reflection of an acoustic signal detected when one or more users input particular content (e.g., text) by interacting with a computing device. In some embodiments, multiple initial training signals may correspond to various user interactions and/or content. Each of the initial training signals may be modulated to carry particular text. This step may be performed by the echo detector 230.

One or more features of the initial training signal(s) may be extracted in step 912. The features to be extracted include time-domain features and frequency-domain features. The time-domain features may include one or more envelopes (e.g., an upper envelope, a lower envelope, etc.), a peak of the envelope(s), a crest of the acoustic signal, a distance between the peak and the crest, and/or any other feature of the acoustic signal in a time domain. The frequency-domain feature may be and/or include one or more frequency components of the acoustic signal, a change in the frequency of the acoustic signal over time, etc. To extract the frequency domain feature, the initial training signals may be analyzed using Fourier-related transform. The Fourier-related transform may be short-time Fourier transform.

The extracted features may form a training set in step 910. This step may be performed by the update unit of the interaction recognition module 430. The obtained training set may be used to train the classification model of the classification unit 720 of the interaction recognition module 430.

In step 910, training data may be obtained. This step may be performed by the update unit of the interaction recognition module 430. The training data may be used to construct and train the classification model. The training data may include multiple training sets corresponding to multiple user interactions and/or content. In some embodiments, a plurality of training sets corresponding to a plurality of user interactions may be obtained (e.g., at step 910). The plurality of training sets may include extracted features from the initial training signal (e.g., one or more features extracted at step 912) and/or extracted features from user interaction identification (e.g., from step 908). The extracted features in the training sets may be labeled. The label may correspond to the particular user interactions. For example, the label may correspond to the particular text that the initial training signal is modulated to carry.

As another example, the label may correspond to the particular text that user inputs. In some embodiments, the training sets may be divided into two groups (e.g., training group and testing group). The training data is used to train and construct the classification model, while the testing data is used to evaluate the training. In some embodiments, the classification model can be constructed based on the plurality of training sets. The training sets may be input into the classification model for machine learning. The classification model may “learn” the extracted features and the particular user interactions that the extracted features correspond to. The testing data may be input into the classification model to evaluate the training. The classification model may classify the extracted features of the testing group and generate a predicted label for each extracted feature of the testing group. The predicted label may or may not be the same as the actual label of the extracted feature.

It should be noted that the above steps of the flow diagrams of FIGS. 3, 6, 8, and 9 can be executed or performed in any order or sequence not limited to the order and sequence shown and described in the figures. Also, some of the above steps of the flow diagrams of FIGS. 3, 6, 8, and 9 can be executed or performed substantially simultaneously where appropriate or in parallel to reduce latency and processing times. Furthermore, it should be noted that FIGS. 3, 6, 8, and 9 are provided as examples only. At least some of the steps shown in these figures can be performed in a different order than represented, performed concurrently, or altogether omitted.

It should be noted that the flowchart described above is provided for the purposes of illustration, and not intended to limit the scope of the present disclosure. Apparently for persons having ordinary skills in the art, numerous variations and modifications may be conducted under the teaching of the present disclosure.

However, those variations and modifications may not depart the protecting scope of the present disclosure.

The entire disclosure of each document cited (including patents, patent applications, journal articles, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure claimed. Thus, it should be understood that although the disclosure has been specifically disclosed by preferred embodiments, exemplary embodiments and optional features, modification and variation of the concepts herein disclosed can be resorted to by those skilled in the art, and that such modifications and variations are considered to be within the scope of this disclosure as defined by the appended claims.

It is also to be understood that the terminology used herein is merely for the purpose of describing particular embodiments, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending,” “receiving,” “generating,” “providing,” “calculating,” “executing,” “storing,” “producing,” “determining,” “reducing,” “transmitting,” “recognizing,” “identifying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “first,” “second,” “third,” “fourth,” etc. as used herein are meant as labels to distinguish among different elements and may not necessarily have an ordinal meaning according to their numerical designation.

In some implementations, any suitable computer readable media can be used for storing instructions for performing the processes described herein. For example, in some implementations, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in connectors, conductors, optical fibers, circuits, any suitable media that is fleeting and devoid of any semblance of permanence during transmission, and/or any suitable intangible media.

When a Markush group or other grouping is used herein, all individual members of the group and all combinations and possible sub-combinations of the group are intended to be individually included in the disclosure. Every combination of components or materials described or exemplified herein can be used to practice the disclosure, unless otherwise stated. One of ordinary skill in the art will appreciate that methods, device elements, and materials other than those specifically exemplified can be employed in the practice of the disclosure without resort to undue experimentation. All art-known functional equivalents, of any such methods, device elements, and materials are intended to be included in this disclosure. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this disclosure. The disclosure illustratively described herein suitably can be practiced in the absence of any element or elements, limitation or limitations that is not specifically disclosed herein.

A number of embodiments of the disclosure have been described. The specific embodiments provided herein are examples of useful embodiments of the disclosure and it will be apparent to one skilled in the art that the disclosure can be carried out using a large number of variations of the devices, device components, methods steps set forth in the present description. As will be obvious to one of skill in the art, methods and devices useful for the present methods can include a large number of optional composition and processing elements and steps.

In particular, it will be understood that various modifications may be made without departing from the spirit and scope of the present disclosure. Accordingly, other embodiments are within the scope of the following claims.

1. A method for recognizing user interactions, comprising:
generating an acoustic signal;
receiving an echo signal representative of a reflection of the acoustic signal from a target;
analyzing, by at least one processor, the echo signal; and
recognizing a user interaction associated with the target based on the analysis.

2. The method of claim 1, wherein the acoustic signal comprises a near-ultrasonic signal.

3. The method of claim 1, wherein the target comprises a user extremity.

4. The method of claim 1, wherein recognizing the user interaction further comprises:
extracting at least one feature from the echo signal;
classifying the at least one feature; and
identifying the user interaction based on the classification.

5. The method of claim 4, further comprising:
recognizing, by the at least one processor, content associated with the user interaction based on the classification.

6. The method of claim 4, further comprising:
recognizing, by the at least one processor, content associated with the user interaction based on at least one processing rule.

7. The method of claim 6, wherein the processing rule comprises a grammar rule.

8. The method of claim 4, wherein the at least one feature comprises at least one of a time-domain feature or a frequency-domain feature.

9. The method of claim 8, wherein the time-domain feature comprises at least one of an envelope of the echo signal, a peak of the envelope, or a crest of the echo signal.

10. The method of claim 8, wherein the frequency-domain feature comprises a change in frequency of the echo signal.

11. The method of claim 4, wherein the classification is performed based on a classification model.

12. The method of claim 11, further comprising:
receiving a plurality of training sets corresponding to a plurality of user interactions; and
constructing the classification model based on the plurality of training sets.

13. The method of claim 12, wherein the classification model is a support vector machine model.

14. The method of claim 1, wherein the acoustic signal is generated at a first frequency, wherein the echo signal is detected at a second frequency, and wherein the second frequency is at least twice of the first frequency.

15. A system for recognizing user interactions, comprising:
at least one storage medium including a set of instructions; and
at least one processor in communication with the at least one storage medium, wherein when executing the set of instructions, the at least one processor is directed to cause the system to:
generate an acoustic signal;
receive an echo signal representative of a reflection of the acoustic signal from a target
analyze the echo signal; and
recognize a user interaction associated with the target based on the analysis.

16. The system of claim 15, wherein the acoustic signal comprises a near-ultrasonic signal.

17. The system of claim 15, wherein the acoustic signal is generated at a first frequency, wherein the echo signal is detected at a second frequency, and wherein the second frequency is at least twice of the first frequency.

18-20. (canceled)

21. The system of claim 15, wherein the at least one processor is directed to cause the system further to:
extract at least one feature from the echo signal;
classify the at least one feature; and
identify the user interaction based on the classification.

22. The system of claim 21, wherein the classification is performed based on a classification model.

23. A non-transitory computer readable storage medium including a set of instructions, when executed by at least one processor, cause the at least one processor to effectuate a method comprising:
generating an acoustic signal;
receiving an echo signal representative of a reflection of the acoustic signal from a target;
analyzing, by the at least one processor, the echo signal; and
recognizing a user interaction associated with the target based on the analysis.
